(19) United States
(12) Patent Application Publication
(10) Pub. No.: US 2014/0093855 A1
(43) Pub. Date: Apr. 3, 2014

(54) SYSTEMS AND METHODS FOR TREATMENT OF LEARNING DISABILITIES

(71) Applicant: Dennis Waldman, Waban, MA (US)

(72) Inventor: Dennis Waldman, Waban, MA (US)

(21) Appl. No.: 14/041,680

(22) Filed: Sep. 30, 2013

Related U.S. Application Data
(60) Provisional application No. 61/708,814, filed on Oct. 2, 2012.

(51) Int. Cl. G09B 5/06

(52) U.S. Cl. CPC G09B 5/065
USPC 434/308

(57) ABSTRACT

Methods, systems, apparatus, and non-transitory computer readable media for treating a user having a learning disability. In embodiments, the method comprises displaying, at a physical location on a display device, at least one graphic element associated with a virtual sound source position in a three dimensional soundfield corresponding to the physical position of the at least one graphic element, and responding to a user selection of one of the at least one graphic elements by playing a three dimensional audio effect having a perceived source located at the virtual sound source position corresponding to the selected graphic element.

### CROSS-REFERENCE TO RELATED APPLICATION

This application claims priority from, and the benefit of, U.S. Provisional Application Ser. No. 61/708,814, filed Oct. 2, 2012, the entirety of which is hereby incorporated by reference herein for all purposes.

### BACKGROUND

1. Technical Field

The present disclosure relates to the treatment of individuals with learning disabilities, and more particularly, to methods of using three dimensional psychoacoustic sound stimulus in association with visual stimulus to treat dyslexia, autism, and other perceptual and learning disabilities.

2. Description of Related Art

Dyslexia, sometimes referred to as Developmental Reading Disorder (DRD), is an information processing disorder in the language interpreting cerebellar-vestibular region of the brain. Symptoms of dyslexia include delayed speed development, letter or number reversal, mirror writing, and being easily distracted by background noise. Notably, dyslexia and attention deficit/hyperactivity disorder (ADHD) are statistically correlated. A child's early reading skills are based on word recognition, which includes being able to distinguish sounds in words and match them with letters and groups of letters. A child with dyslexia often has difficulty separating characters and sounds that make up written and spoken words, which impairs the child's ability to learn reading and writing.

Many people with dyslexia exhibit symptoms of Auditory Processing Disorder (APD), which is a related condition that affects a person's ability to process auditory information. APD is a listening disability which can lead to problems with auditory memory and auditory sequencing. APD is recognized as one of the major causes of dyslexia.

Autism is a complex neurodevelopmental disorder which affects the brain's normal development of social and communication skills. Symptoms of autism gradually begin after the age of six months, become established by age three years, and tend to continue, albeit in somewhat attenuated form, through adulthood. Autism is characterized by three primary symptoms: impairments in social interaction; impairments in communication; and restricted interests and repetitive behavior. Autism encompasses a range of disorders known generally as autism spectrum disorders (ASD) which include, for example, Asperger syndrome. Other symptoms of autism include a lack of intuition that neurotypicals take for granted, difficulty developing symbols into language, and savant syndrome.

A treatment for learning-disabled persons with dyslexia, ADHD, ASD, and the like which does not require the use of medications would be a welcome advance.

### SUMMARY

In one aspect, the present disclosure is directed to a method of treating a user having a learning disability. The method includes displaying, at a physical location on a display device, at least one graphic element associated with a virtual sound source position in a three dimensional soundfield corresponding to the physical position of the at least one graphic element. The method further includes responding to a user selection of one of the at least one graphic elements by playing a three dimensional audio effect having a perceived source located at the virtual sound source position corresponding to the selected graphic element.

In some embodiments, the method further includes applying a visual highlight effect to the selected graphic element.

In some embodiments, the visual highlight effect is applied for a predetermined duration. The three dimensional audio effect may have a duration substantially similar to the duration of the visual highlight effect.

In some embodiments, the method further includes prompting the user to select one of the at least one graphic elements.

In some embodiments, the method further includes recording, in a database operably coupled to the display device, at least one property associated with the prompting. In some embodiments, the method further includes recording, in a database operably coupled to the display device, at least one property associated with the displaying. In some embodiments, the method further includes recording, in a database operably coupled to the display device, at least one property associated with the user selection.

In another aspect, an apparatus for treating a user having a learning disability is disclosed. In an example embodiment, the apparatus includes a processor, a touchscreen display operably coupled to the processor, and an audio output device operably coupled to the processor. The apparatus further includes a computer-readable storage medium operably coupled to the processor including instructions which, when executed on the processor, cause the processor to perform a method that includes the steps of displaying, at a physical location on a touchscreen, at least one graphic element associated with a virtual sound source position in a three dimensional soundfield corresponding to the physical position of the at least one graphic element. The computer-readable storage medium further includes instructions executable on the processor for responding to a user selection of one of the at least one graphic elements by causing to the played, on the audio output device, a three dimensional audio effect having a perceived source located at the virtual sound source position corresponding to the selected graphic element.

In some embodiments, the audio output device is selected from the group consisting of a pair of speakers, a pair of headphones, and a pair of earbuds.

In some embodiments, the computer-readable storage medium further includes instructions executable on the processor for applying a visual highlight effect to the selected graphic element. The visual highlight effect may applied for a predetermined duration. The three dimensional audio effect may have a duration substantially similar to the duration of the visual highlight effect.

In some embodiments, the computer-readable storage medium further includes instructions executable on the processor for prompting the user to select one of the at least one graphic elements.

In some embodiments the computer-readable storage medium further includes instructions executable on the processor for recording, in a database operably coupled to the user device, at least one property associated with the prompting, and recording, in the database, at least one property associated with the user selection.

In yet another aspect of the present disclosure, a system for treating a user having a learning disability is presented. In embodiments, the system includes a user device and a database operably coupled to the user device. The user device includes a processor, a touchscreen display operably coupled to the processor, a communications interface operably coupled to the processor, an audio output device operably coupled to the processor, and a computer-readable storage medium operably coupled to the processor. The computer-readable storage medium includes instructions which, when executed on the processor, cause the processor to perform a method comprising displaying, at a physical location on a touchscreen, at least one graphic element associated with a virtual sound source position in a three dimensional soundfield corresponding to the physical position of the at least one graphic element, and responding to a user selection of one of the at least one graphic elements by causing to the played, on the audio output device, a three dimensional audio effect having a perceived source located at the virtual sound source position corresponding to the selected graphic element. The database is configured to store data selected from the group consisting of a property associated with the displaying and a property associated with the user selection.

In some embodiments, the computer-readable storage medium includes instructions executable on the processor for applying a visual highlight effect to the selected graphic element. In some embodiments, the visual highlight effect is applied for a predetermined duration. In some embodiments, the computer-readable storage medium further includes instructions executable on the processor for prompting the user to select one of the at least one graphic elements. In some embodiments, the database is further configured to store at least one property associated with the prompting.

In still another aspect, the present disclosure is directed to non-transitory computer-readable storage media containing instructions which, when executed on a processor, cause the processor to perform a method of treating a user with a learning disability. The method includes the steps of displaying, at a physical location on a touchscreen, at least one graphic element associated with a virtual sound source position in a three dimensional soundfield corresponding to the physical position of the at least one graphic element, and responding to a user selection of one of the at least one graphic elements by causing to the played, on the audio output device, a three dimensional audio effect having a perceived source located at the virtual sound source position corresponding to the selected graphic element.

In some embodiments, the non-transitory computer-readable storage media includes instructions for applying a visual highlight effect to the selected graphic element. The visual highlight effect may be applied for a predetermined duration. The three dimensional audio effect may have a duration substantially similar to the duration of the visual highlight effect.

In some embodiments, the non-transitory computer-readable storage media includes instructions for prompting the user to select one of the at least one graphic elements.

In some embodiments, the non-transitory computer-readable storage media includes instructions for recording, in a database operably coupled to processor, at least one property associated with the prompting, and recording, in the database, at least one property associated with the user selection.

### BRIEF DESCRIPTION OF THE DRAWINGS

Example embodiments in accordance with the present disclosure are described herein with reference to the drawings wherein:

FIG. 1 is a block diagram of an example embodiment of a user device for treating a learning disability in accordance with the present disclosure;

FIG. 2 depicts a user device and a corresponding 3D soundfield illustrating a first step of method of treating a learning disability in accordance with an example embodiment of the present disclosure;

FIG. 3 depicts a user device and a corresponding 3D soundfield illustrating another aspect of a method of treating a learning disability in accordance with an example embodiment of the present disclosure;

FIG. 4 depicts a user device and a corresponding 3D soundfield illustrating yet another aspect of a method of treating a learning disability in accordance with an example embodiment of the present disclosure;

FIG. 5 depicts a user device and a corresponding 3D soundfield illustrating still another aspect of a method of treating a learning disability in accordance with an example embodiment of the present disclosure;

FIG. 6 depicts a user device and a corresponding 3D soundfield illustrating a further aspect of a method of treating a learning disability in accordance with an example embodiment of the present disclosure;

FIG. 7 depicts a user device and a corresponding 3D soundfield illustrating an additional aspect of a method of treating a learning disability in accordance with an example embodiment of the present disclosure;

FIG. 8 illustrates a 3D soundfield in accordance with an example embodiment of the present disclosure wherein a 3D effect is created along a +Y axis in front of the patient;

FIG. 9 illustrates a 3D soundfield in accordance with an example embodiment of the present disclosure wherein a 3D effect is created along a +Z axis above the patient; and

FIG. 10 illustrates a 3D soundfield in accordance with an example embodiment of the present disclosure wherein a 3D effect is created along a −Y axis behind the patient.

### DETAILED DESCRIPTION

Particular embodiments of the present disclosure are described hereinbelow with reference to the accompanying drawings; however, it is to be understood that the disclosed embodiments are merely examples of the disclosure, which may be embodied in various forms. Well-known and/or repetitive functions and constructions are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In addition, as used herein in the description and in the claims, terms referencing orientation, e.g., “top”, “bottom”, “upper”, “lower”, “left”, “right”, and the like, are used with reference to the figures and features shown and described herein. It is to be understood that embodiments in accordance with the present disclosure may be practiced in any orientation without limitation. In this description, as well as in the drawings, like-referenced numbers represent elements which may perform the same, similar, or equivalent functions.

The present disclosure is directed to a system, apparatus, and related methods for using three dimensional psychoacoustic sound stimulus in association with visual stimulus to treat dyslexia, autism, and other perceptual and learning disabilities. In some embodiments, the method may be embodied as a software program product configured to execute on a processor of a user device. A user device may encompass any suitable computing device, including without limitation, a smart phone (e.g., Apple iPhone®, Android®-based, and Windows Mobile® phones), a tablet device (e.g., Apple iPad®), a notebook computer, a laptop computer, a desktop computer, an interactive television, a touchscreen computer, and the like.

The present disclosure may be described herein in terms of functional block components, code listings, optional selections, page displays, and various processing steps. It should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed by any device having a data connection capable of connecting to the Internet, on a variety of operating systems including without limitation Apple MacOS®, Apple iOS®, Google Android®, HP WebOS®, Linux, UNIX®, Microsoft Windows®, and/or Microsoft Windows Mobile®.

It should be appreciated that the particular implementations described herein are illustrative of the disclosure and its best mode and are not intended to otherwise limit the scope of the present disclosure in any way. Examples are presented herein which may include sample data items which are intended as examples and are not to be construed as limiting. Indeed, for the sake of brevity, conventional data networking, application development and other functional aspects of the systems (and components of the individual operating components of the systems) may not be described in detail herein. It should be noted that many alternative or additional functional relationships or physical or virtual connections may be present in a practical electronic data communications system. In the discussion contained herein, the terms user interface element and/or button are understood to be non-limiting, and include other user interface elements such as, without limitation, a hyperlink, clickable image, and the like.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like.

Computer program instructions embodying the disclosed disclosure may also be stored in a computer-readable memory that can direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like The steps recited herein may be executed in any order and are not limited to the order presented.

The disclosed systems and/or methods may be embodied, at least in part, in application software that may be downloaded from either a website or an application store (“app store”) to the mobile device. In another embodiment, the disclosed system and method may be included in the mobile device firmware, hardware, and/or software.

In yet other embodiments, all or part of the disclosed systems and/or methods may be provided as one or more callable modules, an application programming interface (e.g., an API), a source library, an object library, a plug-in or snap-in, a dynamic link library (e.g., DLL), or any software architecture capable of providing the functionality disclosed herein.

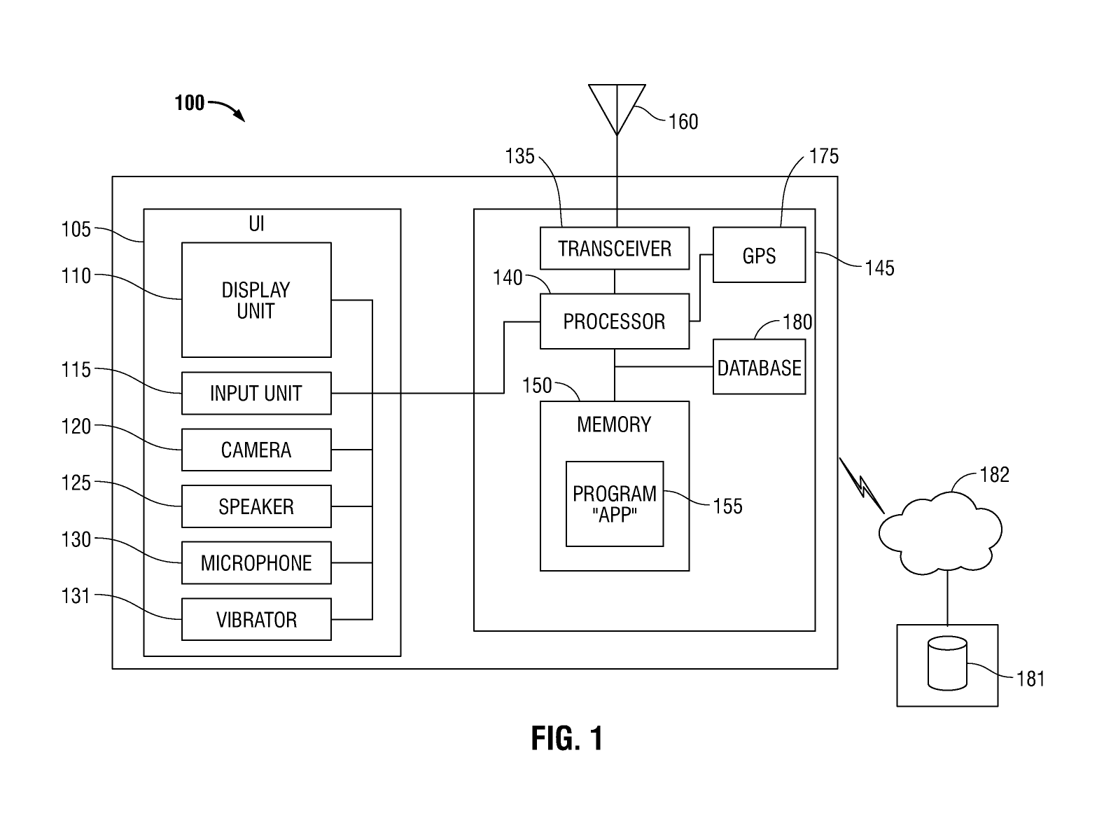

With reference to FIG. 1, a block diagram of an embodiment of a user device 100 in accordance with the present disclosure is presented. User device 100 includes a user interface unit 105 that is configured to enable interaction between user device 100 and a user, and an operational unit 145 that is in operable communication with user interface unit 105. User interface unit 105 includes at least one display unit 110 that is adapted to convey visual information to a user, and may include without limitation a flat panel touchscreen capable of displaying monochrome and/or color images, text, photographs, icons, video, and so forth as will be familiar to the skilled artisan.

User interface unit 105 and/or display unit 110 includes an input unit 115 that is configured to sense inputs received from a user, such as without limitation, finger touches, finger gestures, and/or motion gestures. In an embodiment, input unit 115 may include one or more pushbuttons, a touchscreen, an accelerometer, a gyroscope, and/or combinations thereof. User interface unit 105 includes one or more speakers 120 configured to provide three-dimensional (3D) simulated audio sound to a user. The 3D audio capabilities of the one or more speakers 120 and related hardware and software enables realistic and convincing localizations of sound which are perceived to originate from arbitrary positions within space around the listener, e.g., from sources located in around, in front of, behind, above, and below the listener. In some embodiments, human head related transfer functions, time delay, comb filtering, and reverberation are used to simulate the changes of sound on its way from the source, including reflections from walls and floors, to the listener's ears. In some embodiments, the one or more speakers 120 includes a pair of earbuds or headphones.

User interface unit 105 includes one or more microphones 130 configured to capture speech and/or other audio signals. User interface unit 105 includes at least one camera 125 that facilitates the capture of photographic (still) and video (moving) images. In some embodiments, camera 125 may be configured to track eye motion of a user to determine where on display unit 110 the user is focused while reading and/or viewing the material presented on display unit 110. User interface unit includes a vibrator 131 that may be selectively activated to generate haptic feedback and/or tactile stimulation.

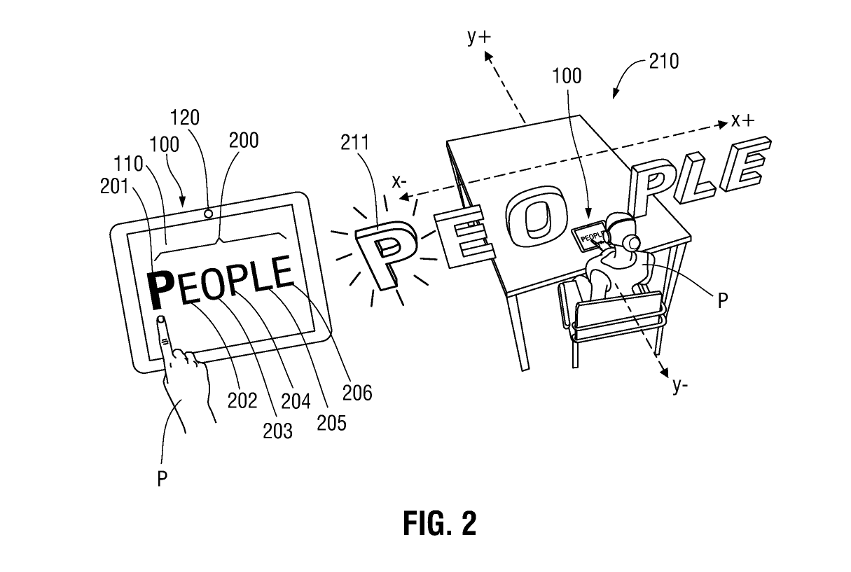

Operational unit 145 includes a data communications interface 135 adapted to facilitate data communications between user device 100 and wireless data network 182. Data communications interface 135 may include a cellular and/or WiFi transceiver having radiofrequency modulating and demodulating units (not shown) that is configured to encode and decode, respectively, data communications. In the embodiment illustrated in FIG. 2, data communications interface 135 is operably coupled to an antenna 160 which, in turn, facilitates communication among and between user device 100 and other devices, such as a remote database 181 and/or an application store (not shown). In embodiments, data communications interface 135 may additionally or alternatively support hardwired communications (e.g., Ethernet).

Operational unit 145 further includes a processor 140 that is operably coupled to transceiver 135, a memory 150, a database 180, and a software application including a set of programmed instructions, which, when executed by the processor 140, performs a method of treating learning disabilities as described herein.

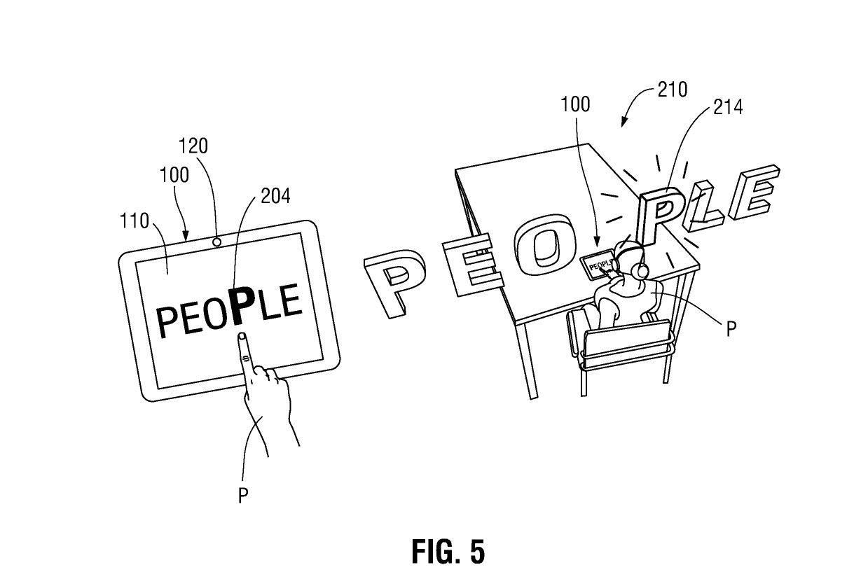

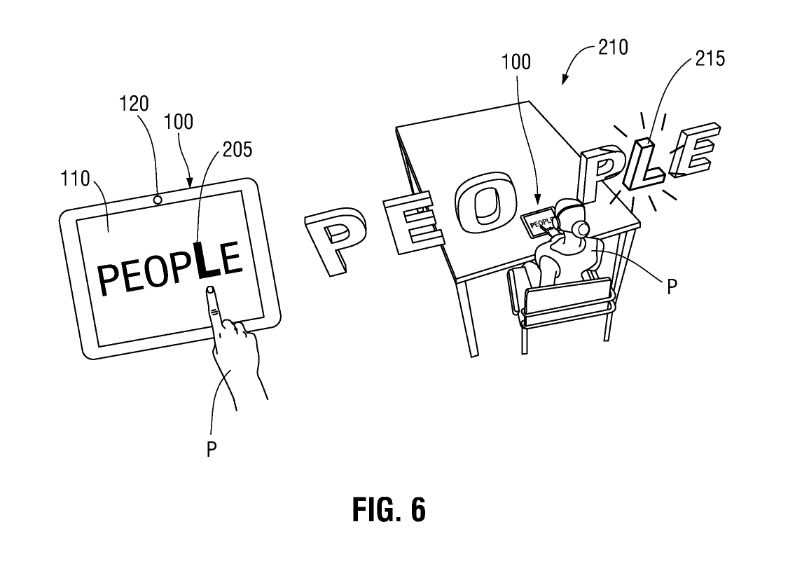

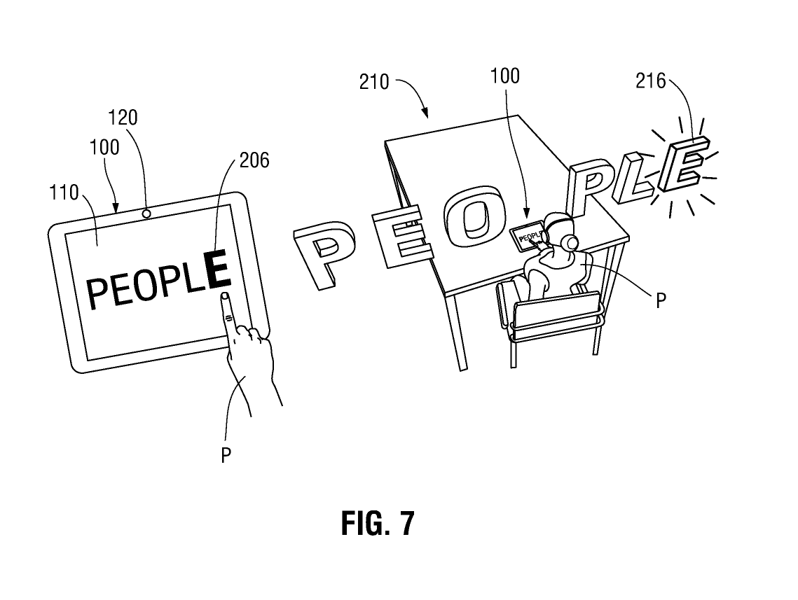

With reference now to FIGS. 2-7, a computer-implemented method for treating individuals with a learning disability is described. The disclosed method is executed on processor 140 and utilizes 3D sound processing to immerse the patient in an environment in which three of their senses are simultaneously stimulated to see, touch, and hear the correct spatial orientation of letters, syllables, and words presented on display unit 110 (e.g., left/right, up/down, forward/rearward). For example, and without limitation, the coordinating sound is produced with left to right panning and with 3D techniques to create an environment in which the user perceives the sound to be coming from behind the user (left to right), coming from in front of the user (left to right), or coming above the user (left to right).

In use, a patient or caregiver installs, initializes, and/or activates the application software on user device 100 which includes a set of programmed instructions, which, when executed by the processor 140, performs an exercise in accordance with the described method of treating learning disabilities.

In a non-limiting example exercise, a word or phrase 200 is displayed on display unit 110 to a patient. In the example presented in FIG. 2, a word 200 comprised of letters 201, 202, 203, 204, 250, and 206 forming the word “PEOPLE” is presented on display unit 110 of user device 100. As the user touches each letter, a visual feedback effect is generated (e.g., a glow effect, a bold effect, and/or the letter gets larger, pulses, changes color, etc.) while the user hears the appropriate phoneme for that letter, in 3D space, based on a relative left to right sequence of appropriate spacing for that word. Therefore, as the letters are highlighted in a progressive order from left to right, the sound also travels from left to right. The same process is used for syllables and phrases. In embodiments, a series of one or more words or phrases may be presented in succession. In some embodiments, graphic icons which do not necessarily depict letters of other language elements may be employed, e.g., circles, squares, shapes, characters, and the like may be employed.

For example, as shown in FIG. 2, the patient P touches the first, leftmost letter 201 which in the present example corresponds to the letter “P” in the word “PEOPLE.” As the letter 201 is touched, a visual highlight effect is applied to letter 201. Concurrently thereto, a 3D audio effect is played such that patient P localizes the source of the 3D audio effect as emanating from the on-screen position of letter 201. Audio environment 210 pictorially represents the perceptual mapping of the 3D audio effect as heard by patient P, which is mapped in a substantially left-right sound field along the path indicated by axis X−/X+. Continuing with the present example, the 3D audio effect is caused to be generated by the one or more speakers 120 when the patient touches letter 201 is such that it appears to originate from virtual sound source 211 (represented in space by the letter “P”).

In some embodiments, the visual highlight effect is applied for a predetermined or temporary period of time, e.g., for less than about one second. In some embodiments, the visual highlight effect persists until a subsequent letter is touched. In some embodiments, the visual highlight effect persists for the duration of the exercise (e.g., to indicate to the patient and/or caregiver that the associated letter has already been chosen).

In some embodiments, the duration of the visual highlight effect applied to letter 201 corresponds to the duration of the 3D audio effect originating from virtual sound source 211. In this manner, the visual and audible stimulation combine to reinforce the therapeutic benefits received by patient P. In some embodiments, display unit 110 includes a haptic feedback mechanism which provides tactile stimulus to the patient in response to a screen touch. In these embodiments, the duration of the haptic feedback stimulus corresponds to the duration of the visual highlight effect and the duration of the 3D audio effect. In some embodiments, any one, some, or all of the visual highlight effect, the 3D audio effect, and/or haptic stimulus effect are modulated in a similar manner. For example, without limitation, the visual highlight effect may include an animation showing three “pulses” of decreasing intensity applied to the corresponding letter, the 3D audio effect may include three echoes or reverberations of decreasing intensity that are synchronized to the visual highlight effect, and the haptic stimulation may include three vibrations of decreasing intensity that are synchronized to the visual highlight effect. In embodiments, the 3D audio effect may include the pronunciation of the selected character or word, which may be generated using a sampled recording of the pronunciation and/or a text-to-speech algorithm, as will be appreciated by the skilled artisan.

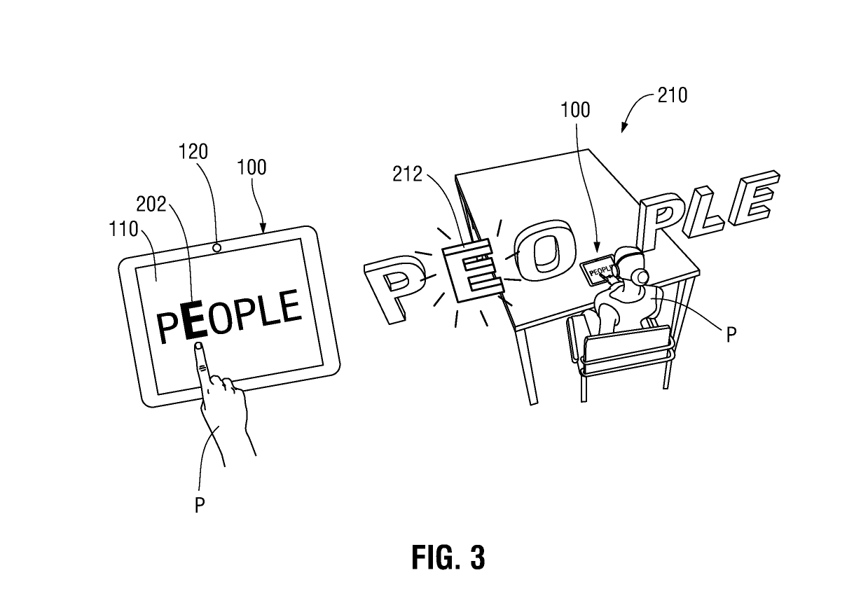

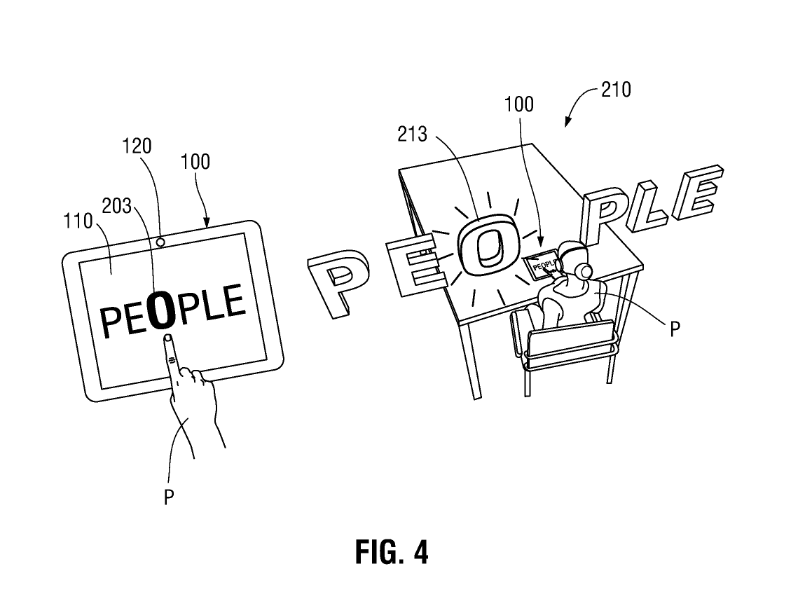

Continuing with the present example depicted in FIGS. 3-7, the patient continues to interact with user device 100 in a similar manner with respect to the subsequent letters of the current exercise. Thus, as shown in FIG. 3, patient P touches the second letter 202 corresponding to the letter “E” in the word “PEOPLE” which, in turn, causes 3D audio effect to be generated which is perceived to originate from virtual sound source 212 (represented in space by the letter “E”); the patient then touches the third letter 203 causing a 3D sound to appear to emanate from virtual sound source 213, and so forth with respect to the remaining letters as shown in FIGS. 4-7.

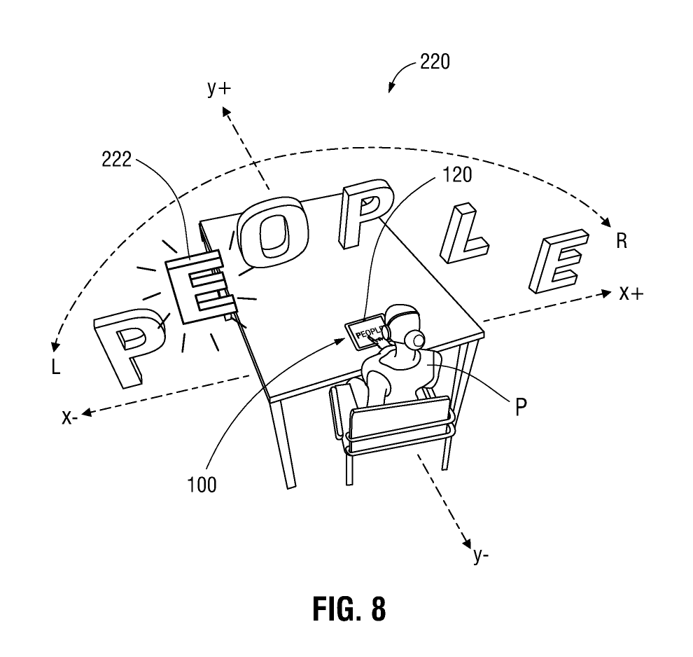

Turning now to FIG. 8, another example embodiment of a computer-implemented method for treating individuals with a learning disability in accordance with the present disclosure is presented. In the FIG. 8 example, audio environment 220 pictorially represents the perceptual mapping of the 3D audio effect as heard by patient P, which is mapped in an arc 222 spanning a substantially left-right sound field along the path indicated by axis X−/X+ and curving into the distance, e.g., in the Y+ direction along the Y−/Y+ axis. The audio mapping along arc 222 may correspond with graphic elements depicted on user device 100, e.g., the graphics elements may appear to curve into the distance in manner mimicking the 3D audio effect. By reinforcing the visual and audible cues in this manner, more effective treatment may be achieved.

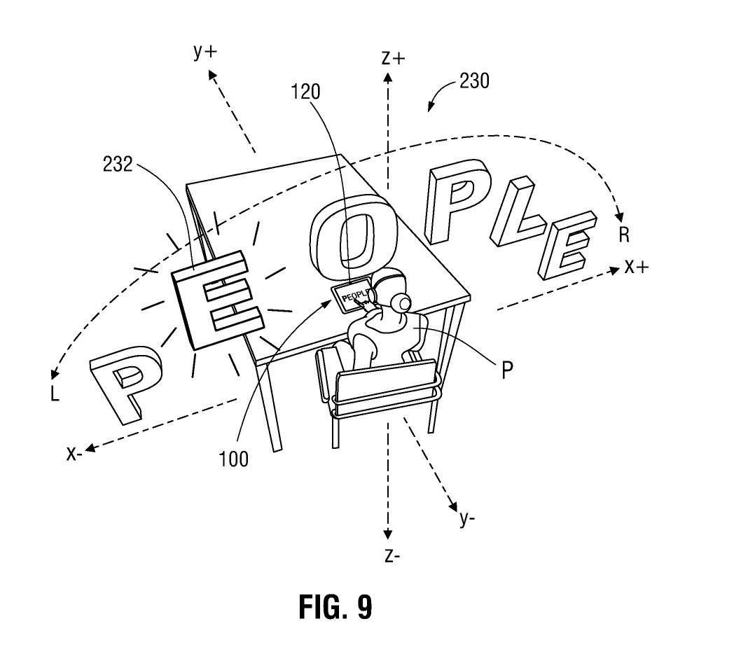

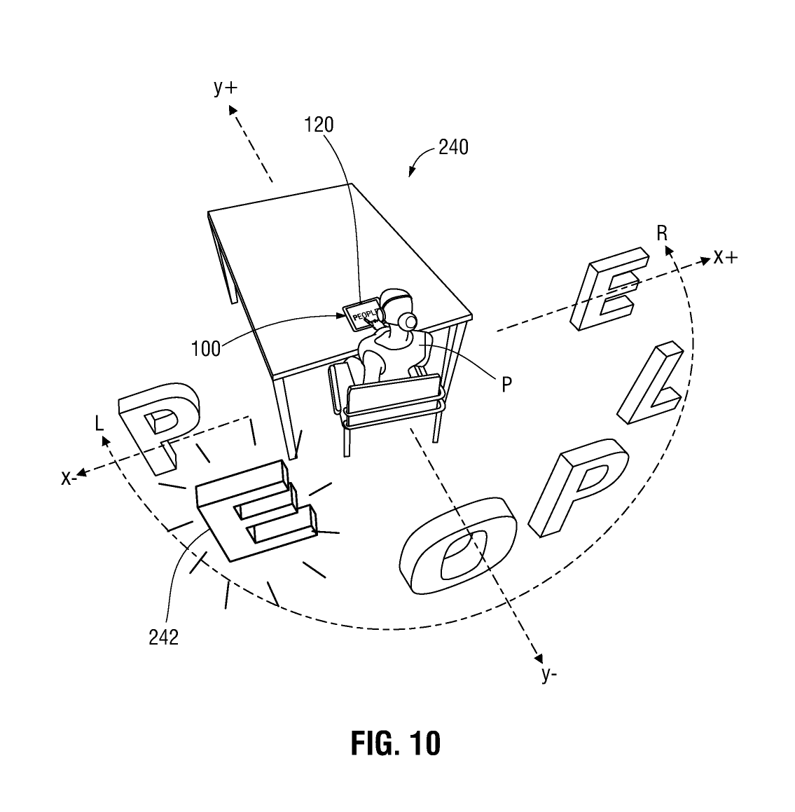

FIGS. 9 and 10 illustrate yet other example embodiments of audio environments for use with a method in accordance with the present disclosure. In the example depicted in FIG. 9, audio environment 230 pictorially represents the perceptual mapping of the 3D audio effect as heard by patient P, which is mapped in an arc 232 spanning a substantially left-right sound field along the path indicated by axis X−/X+ and curving upward over patient P, e.g., in the Z+ direction along the Z−/Z+ axis. The audio mapping along arc 232 may correspond with graphic elements depicted on user device 100, e.g., the graphics elements may appear to arc upward the distance in manner mimicking the 3D audio effect. In FIG. 10, audio environment 240 includes a 3D audio effect as heard by patient P that is mapped in an arc 242 spanning a substantially left-right sound field along the path indicated by axis X−/X+ and curving behind patient P, e.g., in the Y− direction along the Y−/Y+ axis. The audio mapping along arc 242 may correspond with graphic elements depicted on user device 100, as described above.

In still another embodiment, for example as shown in FIG. 8, camera 120 may be utilized to identify and track the eye movements of patient P as patient P interacts with user device 100, and, in turn, cause the corresponding 3D audio effect and/or visual highlight effect to be generated dynamically as the user focuses on the graphic elements displayed on display unit 110. Eye movement tracking may be used in addition to, or alternatively to, user touch inputs as described above.

In some embodiments, the patient is prompted to touch an on-screen icon (e.g., letter, number, symbol, pictogram, etc.) using a visual prompt and/or an aural prompt. The aural prompt may include a verbal command (e.g., “touch the second letter of the word”, “touch the ‘A’”, etc.) and/or a 3D audio effect. The 3D audio effect may include the verbal command spatialized at the position of the intended icon or may include a non-verbal sound effect. The visual prompt may include a graphic effect (e.g., a glow or outline effect applied to the icon, a text prompt, and so forth). The system then evaluates the patient's response to determine whether the indicated icon was correctly touched. If the correct response was given, a subsequent, possibly different, icon is prompted to the user. If an incorrect response is given, the prompt may be repeated and/or flagged to be repeated during the current exercise. In embodiments, an incorrect response may be flagged for multiple subsequent repetitions in order to reinforce the patient's learning. In some embodiments, a record of the patient's interactions (e.g., prompted symbols, responses, response times, false touches, hesitant touches, etc.) may be stored for later presentation to the caregiver and/or analysis may be performed on the data (e.g., correct answer rate, average/median response time, etc.) The results may be uploaded to a centralized database for population analysis and other clinical research purposes.

In yet another embodiment, a text-to-speech converter may be utilized in combination with eye movement tracking to provide dynamic reinforcement of text displayed on display unit 110. Thus, as patient R reads the on-screen text, the words being read are recited, in 3D audio space, at a perceived position corresponding to the location of each word as displayed on display unit 110.

The described embodiments of the present disclosure are intended to be illustrative rather than restrictive, and are not intended to represent every embodiment of the present disclosure. Further variations of the above-disclosed embodiments and other features and functions, or alternatives thereof, may be made or desirably combined into many other different systems or applications without departing from the spirit or scope of the disclosure as set forth in the following claims both literally and in equivalents recognized in law.

What is claimed is:

1. A method of treating a user having a learning disability, comprising:
displaying, at a physical location on a display device, at least one graphic element associated with a virtual sound source position in a three dimensional soundfield corresponding to the physical position of the at least one graphic element; and
responding to a user selection of one of the at least one graphic elements by playing a three dimensional audio effect having a perceived source located at the virtual sound source position corresponding to the selected graphic element.

2. The method in accordance with claim 1, wherein the responding further includes applying a visual highlight effect to the selected graphic element.

3. The method in accordance with claim 2, wherein the visual highlight effect is applied for a predetermined duration.

4. The method in accordance with claim 3, wherein the three dimensional audio effect has a duration substantially similar to the duration of the visual highlight effect.

5. The method in accordance with claim 1, further comprising prompting the user to select one of the at least one graphic elements.

6. The method in accordance with claim 5, further comprising:
recording, in a database operably coupled to the display device, at least one property associated with the prompting.

7. The method in accordance with claim 1, further comprising:
recording, in a database operably coupled to the display device, at least one property associated with the displaying.

8. The method in accordance with claim 1, further comprising:
recording, in a database operably coupled to the display device, at least one property associated with the user selection.

9. Apparatus for treating a user having a learning disability, comprising:
a processor;
a touchscreen display operably coupled to the processor;
an audio output device operably coupled to the processor; and
a computer-readable storage medium operably coupled to the processor including instructions which, when executed on the processor, cause the processor to perform a method comprising:
displaying, at a physical location on a touchscreen, at least one graphic element associated with a virtual sound source position in a three dimensional soundfield corresponding to the physical position of the at least one graphic element; and
responding to a user selection of one of the at least one graphic elements by causing to the played, on the audio output device, a three dimensional audio effect having a perceived source located at the virtual sound source position corresponding to the selected graphic element.

10. The apparatus in accordance with claim 9, wherein the audio output device is selected from the group consisting of a pair of speakers, a pair of headphones, and a pair of earbuds.

11. The apparatus in accordance with claim 9, wherein the computer-readable storage medium further includes instructions executable on the processor for applying a visual highlight effect to the selected graphic element.

12. The apparatus in accordance with claim 11, wherein the visual highlight effect is applied for a predetermined duration.

13. The apparatus in accordance with claim 12, wherein the three dimensional audio effect has a duration substantially similar to the duration of the visual highlight effect.

14. The apparatus in accordance with claim 9, wherein the computer-readable storage medium further includes instructions executable on the processor for prompting the user to select one of the at least one graphic elements.

15. The apparatus in accordance with claim 14, wherein the computer-readable storage medium further includes instructions executable on the processor for:
recording, in a database operably coupled to the user device, at least one property associated with the prompting; and
recording, in the database, at least one property associated with the user selection.

16. A system for treating a user having a learning disability, comprising:
a user device, comprising:
a processor;
a touchscreen display operably coupled to the processor;
a communications interface operably coupled to the processor;
an audio output device operably coupled to the processor; and
a computer-readable storage medium operably coupled to the processor including instructions which, when executed on the processor, cause the processor to perform a method comprising:
displaying, at a physical location on a touchscreen, at least one graphic element associated with a virtual sound source position in a three dimensional soundfield corresponding to the physical position of the at least one graphic element; and
responding to a user selection of one of the at least one graphic elements by causing to the played, on the audio output device, a three dimensional audio effect having a perceived source located at the virtual sound source position corresponding to the selected graphic element; and
a database in operable communication configured to store data selected from the group consisting of a property associated with the displaying and a property associated with the user selection.

17. The system in accordance with claim 16, wherein the computer-readable storage medium further includes instructions executable on the processor for applying a visual highlight effect to the selected graphic element.

18. The system in accordance with claim 17, wherein the visual highlight effect is applied for a predetermined duration.

19. The system in accordance with claim 16, wherein the computer-readable storage medium further includes instructions executable on the processor for prompting the user to select one of the at least one graphic elements.

20. The system in accordance with claim 19, wherein the database is further configured to store at least one property associated with the prompting.

21. Non-transitory computer-readable storage media comprising instructions which, when executed on a processor, cause the processor to perform a method comprising:
displaying, at a physical location on a touchscreen, at least one graphic element associated with a virtual sound source position in a three dimensional soundfield corresponding to the physical position of the at least one graphic element; and
responding to a user selection of one of the at least one graphic elements by causing to the played, on the audio output device, a three dimensional audio effect having a perceived source located at the virtual sound source position corresponding to the selected graphic element.

22. The non-transitory computer-readable storage media according to claim 21, further comprising instructions for applying a visual highlight effect to the selected graphic element.

23. The non-transitory computer-readable storage media according to claim 22, wherein the visual highlight effect is applied for a predetermined duration.

24. The non-transitory computer-readable storage media according to claim 22, wherein the three dimensional audio effect has a duration substantially similar to the duration of the visual highlight effect.

25. The non-transitory computer-readable storage media according to claim 21, further comprising instructions for prompting the user to select one of the at least one graphic elements.

26. The non-transitory computer-readable storage medium according to claim 21, further comprising instructions for:
recording, in a database operably coupled to processor, at least one property associated with the prompting; and
recording, in the database, at least one property associated with the user selection.
